(19) United States
(12) Patent Application Publication
(10) Pub. No.: US 2022/0329763 A1
(43) Pub. Date: Oct. 13, 2022

(54) Systems and Methods for Obtaining and Disseminating a Live Feed in an Emergency Situation

(71) Applicant: INCOGNITO SECURITY, LLC, Inverness, FL (US)

(72) Inventor: Kerry R. Simmons, Inverness, FL (US)

(21) Appl. No.: 17/715,387

(22) Filed: Apr. 7, 2022

Related U.S. Application Data
(60) Provisional application No. 63/172,366, filed on Apr. 8, 2021.

(51) Int. Cl. H04N 7/18; G06F 21/31

(52) U.S. Cl. CPC H04N 7/183; G06F 21/31

(57) ABSTRACT

A method, computer program product, and computer system for monitoring, by a computing device, for a trigger event at a first location. An occurrence of the trigger event at the first location may be determined. A real-time video feed of the first location may be sent to a first responder based upon, at least in part, determining the occurrence of the trigger event at the first location.

### RELATED CASES

This application claims the benefit of U.S. Provisional Application No. 63/172,366 filed on 8 Apr. 2021, the contents of which are all incorporated by reference.

### BACKGROUND

The Internet has dramatically changed the way people around the world do many things and has particularly impacted the field of security. Security has become increasingly improved and combining this fact with the advent of new technologies, such as improved encryption and increased bandwidth capability, has continued to accommodate the increased desire for increased security.

### BRIEF SUMMARY OF DISCLOSURE

In one example implementation, a method, performed by one or more computing devices, may include but is not limited to monitoring, by a computing device, for a trigger event at a first location. An occurrence of the trigger event at the first location may be determined. A real-time video feed of the first location may be sent to a first responder based upon, at least in part, determining the occurrence of the trigger event at the first location.

One or more of the following example features may be included. Sending the real-time video feed of the first location to the first responder may include receiving authorization to view the real-time video feed of the first location from a security center. The real-time video feed of the first location may be stored in remote storage based upon, at least in part, determining the occurrence of the trigger event at the first location. The trigger event may include a facial recognition match. The trigger event may include a noise matched to a noise database. The trigger event may include a voice activation command. The trigger event may include manual activation.

In another example implementation, a computing system may include one or more processors and one or more memories configured to perform operations that may include but are not limited to monitoring for a trigger event at a first location. An occurrence of the trigger event at the first location may be determined. A real-time video feed of the first location may be sent to a first responder based upon, at least in part, determining the occurrence of the trigger event at the first location.

One or more of the following example features may be included. Sending the real-time video feed of the first location to the first responder may include receiving authorization to view the real-time video feed of the first location from a security center. The real-time video feed of the first location may be stored in remote storage based upon, at least in part, determining the occurrence of the trigger event at the first location. The trigger event may include a facial recognition match. The trigger event may include a noise matched to a noise database. The trigger event may include a voice activation command. The trigger event may include manual activation.

In another example implementation, a computer program product may reside on a computer readable storage medium having a plurality of instructions stored thereon which, when executed across one or more processors, may cause at least a portion of the one or more processors to perform operations that may include but are not limited to monitoring for a trigger event at a first location. An occurrence of the trigger event at the first location may be determined. A real-time video feed of the first location may be sent to a first responder based upon, at least in part, determining the occurrence of the trigger event at the first location.

One or more of the following example features may be included. Sending the real-time video feed of the first location to the first responder may include receiving authorization to view the real-time video feed of the first location from a security center. The real-time video feed of the first location may be stored in remote storage based upon, at least in part, determining the occurrence of the trigger event at the first location. The trigger event may include a facial recognition match. The trigger event may include a noise matched to a noise database. The trigger event may include a voice activation command. The trigger event may include manual activation.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a security process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a security process according to one or more example implementations of the disclosure; and

FIG. 4 is an example alternative diagrammatic view of the distributed computing network of FIG. 1 according to one or more example implementations of the disclosure.

Like reference symbols in the various drawings may indicate like elements.

### DETAILED DESCRIPTION

### System Overview:

As noted above, the Internet has dramatically changed the way people around the world do many things and has particularly impacted the field of security. Security has become increasingly improved and combining this fact with the advent of new technologies, such as improved encryption and increased bandwidth capability, has continued to accommodate the increased desire for increased security. However, current security solutions are not communicated in real-time to law enforcement, thus slowing the response time of law enforcement. Moreover, the current solutions are typically local, making them prone to countermeasures, and compromise.

Therefore, as will be discussed in greater detail below, the present disclosure may provide a unique, live real-time video feed from a location (e.g., a retail store) under attack to a second location (e.g., police dispatcher, to responding police/EMS or other target destinations). The feed and other associated communications may be securely connected and cannot be monitored by assailants. The video feeds and incidents may be made available to local authorities and/or other Federal law enforcement organizations, and may be stored in the cloud to prevent destruction of critical evidence at the site of the infraction.

The present disclosure, as will also be discussed in greater detail below, generally relates to systems and methods for providing law enforcement (or other end user such as a homeowner) with an instant live (or near live) real-time feed. In some implementations, the present disclosure may include providing law enforcement (or other end user) with an encrypted instant (or near live) real-time feed of an institution or a business (or other establishment) in an emergency situation. In some implementations, the present disclosure may include, e.g., a server system with a processor system, a communications interface, a communications system, an input system and an output system, the server system having access to a communications network, a memory system with an operating system, a communications module, a web browser module, a web server application that may, in any combination provide law enforcement with an encrypted instant live feed of an institution or a business in an emergency situation non-transitory storage media, the memory system may be in communication with the server system through providing law enforcement with an encrypted instant live feed of an institution or a business in an emergency situation non-transitory storage media, and a website having a plurality of web pages, the web pages may be associated with the providing law enforcement with an encrypted instant live feed of an institution or a business in an emergency situation non-transitory storage media. It will be appreciated that the feed may also be visible in non-emergency situations. It will also be appreciated that while law enforcement is described, other examples may be used as well (e.g., first responders, security call centers, dispatchers, a 911 call center, a local law enforcement station, a state law enforcement station, and a Federal Bureau of Investigation or FBI office, etc.), which may decrypt the streaming feed data.

In some implementations, the present disclosure may provide law enforcement with an encrypted talk to text instant live feed of an institution or a business in an emergency situation, which may include activating a live eye device (e.g., security camera with audio/video capabilities), notifying an emergency call center and/or law enforcement agent, and responding with a patrol officer.

In some implementations, the present disclosure may include providing law enforcement with an encrypted talk to text instant live feed of an institution or a business in an emergency situation that includes a video and audio transmitter device that sends a signal to a receiver via a plurality of encrypted data. In some implementations, the present disclosure may include providing law enforcement with a video and audio transmitter device with a receiver that are both active and the receiver will display the name and the location of the transmitter device as well as a live audio and video feed. It will be appreciated that the terms “live” and “real-time” may be used interchangeably. It will also be appreciated that the terms “live” and “real-time” may include some delay, which may be caused by natural phenomena (e.g., bandwidth, transmission time, etc.) as well as an intentional predetermined delay (e.g., 3-4 seconds). As such, unless other stated, the terms “live” and “real-time” should be interpreted to be either their common usage (i.e., transmitted and received as instantaneously as possible with the time of occurrence) or their common usage with some natural or intentional delay.

In some implementations, the present disclosure may include a receiver that will be on standby mode until a transmission is received from a dedicated transmitter that will also be on standby mode until it is activated by a triggering event, such as remote control or by voice, etc., described further below. In some implementations, the present disclosure may include a plurality of incoming data (e.g., the feed) that may be stored in a dedicated server(s) with no Internet connection to prevent outside tampering. In some implementations, the present disclosure may include a plurality of data (e.g., the feed) that may include a business name and a location that will be preprogrammed in the transmitter and displayed with the feed. In some implementations, a website or a wireless portal may be used to access the live-feed.

In some implementations, as will be discussed in greater detail below, the present disclosure may include facial recognition with fast and secure communications. Within the client establishment, the design may include a small hardware unit that supports both wired and wireless cameras capable of facial recognition as well as sound recognition. When activated, the system may send a live real-time (or near real-time) video feed to a secure cloud environment. The system may then alert the local law enforcement call center and enable the responding operator to provide a link of the video feed to the responding officers. The video feed may also be stored in the cloud, may be secure and cannot be accessed by anyone expect authorized system personnel. Even if the equipment is destroyed, video evidence may be preserved in the secure cloud. This evidence may be used later by the law enforcement professionals to match known criminals via their facial recognition system, as well as become a trigger to activate the system. Prosecutors may use this evidence during trial.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

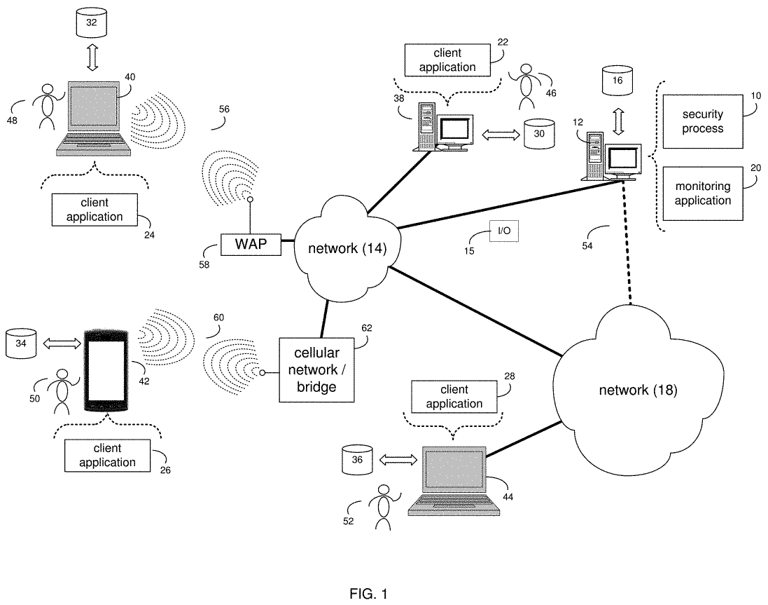

Referring now to the example implementation of FIG. 1, there is shown security process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a security process, such as security process 10 of FIG. 1, may monitor, by a computing device, for a trigger event at a first location. An occurrence of the trigger event at the first location may be determined. A real-time video feed of the first location may be sent to a first responder based upon, at least in part, determining the occurrence of the trigger event at the first location.

In some implementations, the instruction sets and subroutines of security process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, security process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a monitoring application (e.g., monitoring application 20), examples of which may include, but are not limited to, e.g., a facial recognition application, a speech recognition application, examples of which may include, but are not limited to, e.g., an automatic speech recognition (ASR) application (e.g., modeling, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a noise recognition application, a web conferencing application, a video conferencing application, a voice-over-IP application, a video-over-IP application, an Instant Messaging (IM)/“chat” application, a short messaging service (SMS)/multimedia messaging service (MMS) application, or other application that allows for virtual meeting, remote collaboration, or the obtaining and dissemination of video/audio feeds. In some implementations, security process 10 and/or monitoring application 20 may be accessed via one or more of client applications 22, 24, 26, 28. In some implementations, security process 10 may be a standalone application, or may be an applet/application/script/extension that may interact with and/or be executed within monitoring application 20, a component of monitoring application 20, and/or one or more of client applications 22, 24, 26, 28. In some implementations, monitoring application 20 may be a standalone application, or may be an applet/application/script/extension that may interact with and/or be executed within security process 10, a component of security process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of security process 10 and/or monitoring application 20. Examples of client applications 22, 24, 26, 28 may include, but are not limited to, e.g., a facial recognition application, a speech recognition application, examples of which may include, but are not limited to, e.g., an automatic speech recognition (ASR) application (e.g., modeling, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a noise recognition application, a web conferencing application, a video conferencing application, a voice-over-IP application, a video-over-IP application, an Instant Messaging (IM)/“chat” application, a short messaging service (SMS)/multimedia messaging service (MMS) application, or other application that allows for virtual meeting, remote collaboration, or the obtaining and dissemination of video/audio feeds, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone (such as those embedded within eyeglasses, smart phones, tablet computers and/or watches, cameras, etc.), and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of security process 10 (and vice versa). Accordingly, in some implementations, security process 10 may be a purely server-side application, a purely client-side application, or a hybrid server-side/client-side application that is cooperatively executed by one or more of client applications 22, 24, 26, 28 and/or security process 10.

In some implementations, one or more of client applications 22, 24, 26, 28 may be configured to effectuate some or all of the functionality of monitoring application 20 (and vice versa). Accordingly, in some implementations, monitoring application 20 may be a purely server-side application, a purely client-side application, or a hybrid server-side/client-side application that is cooperatively executed by one or more of client applications 22, 24, 26, 28 and/or monitoring application 20. As one or more of client applications 22, 24, 26, 28, security process 10, and monitoring application 20, taken singly or in any combination, may effectuate some or all of the same functionality, any description of effectuating such functionality via one or more of client applications 22, 24, 26, 28, security process 10, monitoring application 20, or combination thereof, and any described interaction(s) between one or more of client applications 22, 24, 26, 28, security process 10, monitoring application 20, or combination thereof to effectuate such functionality, should be taken as an example only and not to limit the scope of the disclosure.

In some implementations, one or more of users 46, 48, 50, 52 may access computer 12 and security process 10 (e.g., using one or more of client electronic devices 38, 40, 42, 44) directly through network 14 or through secondary network 18. Further, computer 12 may be connected to network 14 through secondary network 18, as illustrated with phantom link line 54. Security process 10 may include one or more user interfaces, such as browsers and textual or graphical user interfaces, through which users 46, 48, 50, 52 may access security process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12 (and vice versa). Examples of I/O request 15 may include but are not limited to, data write requests (e.g., a request that content be written to computer 12) and data read requests (e.g., a request that content be read from computer 12), as well as any audio/video feeds.

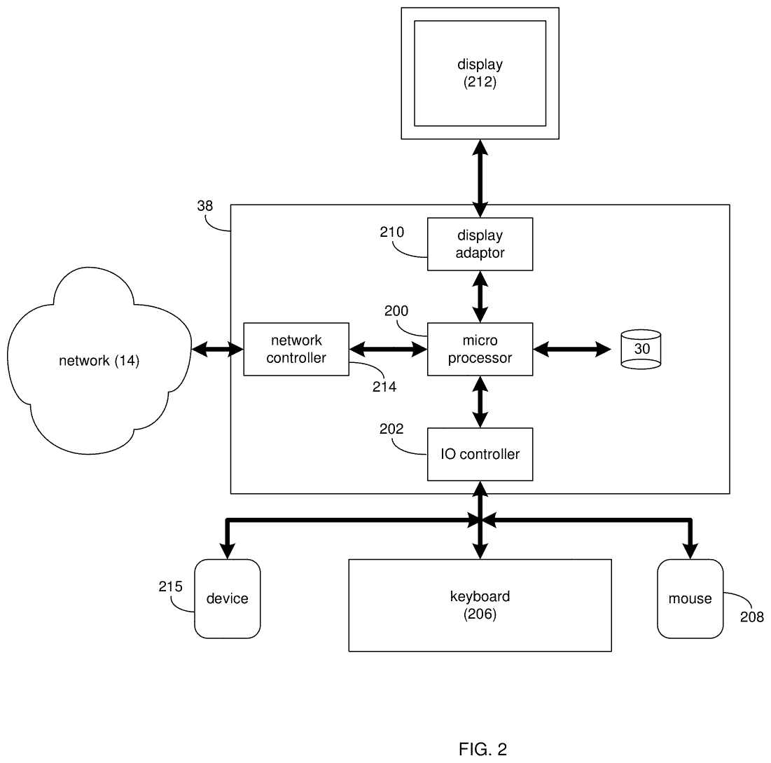

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, security process 10 may be substituted for client electronic device 38 (in whole or in part) within FIG. 2, examples of which may include but are not limited to computer 12 and/or one or more of client electronic devices 40, 42, 44.

In some implementations, client electronic device 38 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215, such as a camera, microphone, or other audio/video input devices), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

The Security Process:

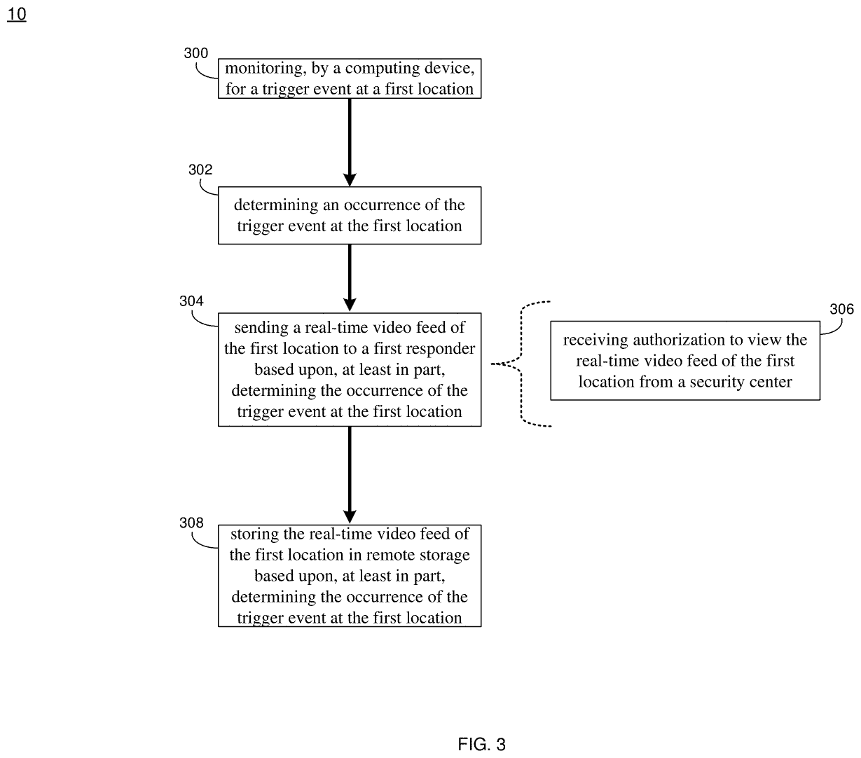

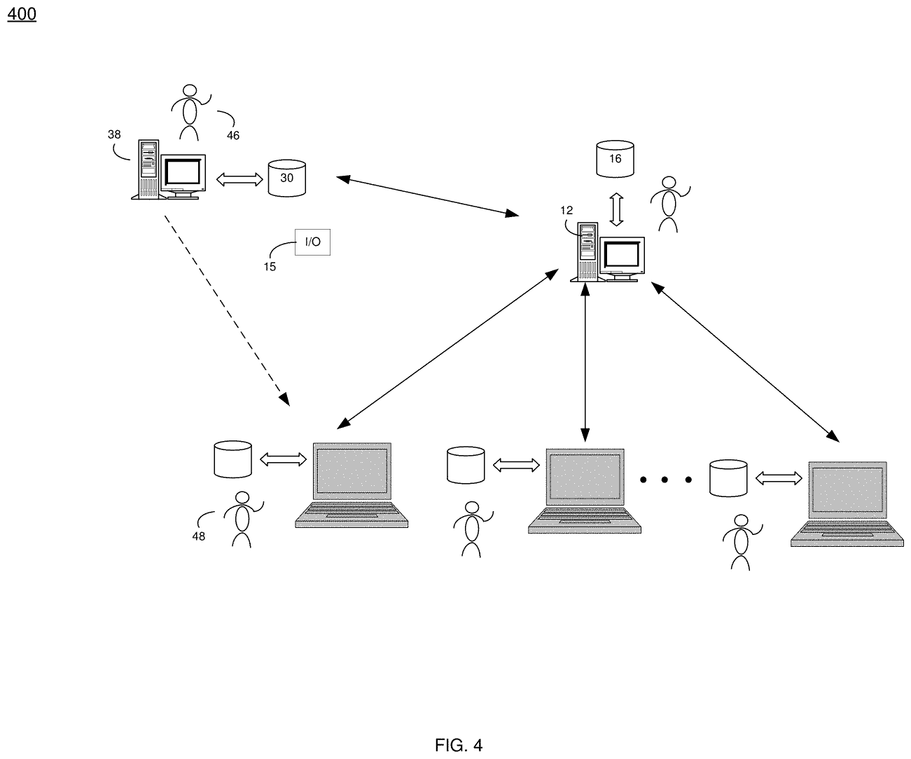

As discussed above and referring also at least to the example implementations of FIGS. 3-4, security process 10 may monitor 300, by a computing device, for a trigger event at a first location. Security process 10 may determine 302 an occurrence of the trigger event at the first location. Security process 10 may send 304 a real-time video feed (e.g., I/O 15) of the first location to a first responder based upon, at least in part, determining the occurrence of the trigger event at the first location.

In some implementations, security process 10 may monitor 300, by a computing device, for a trigger event at a first location. For instance, assume for example purposes that user 46 is a bank teller. In the example, client electronic device 38 (e.g., via security process 10) may monitor 300 for a trigger event at the first location (e.g., the bank). As will be discussed in greater detail below, in some implementations, the trigger event may include a facial recognition match, a noise matched to a noise database, a voice activation command, and/or manual activation.

In some implementations, security process 10 may determine 302 an occurrence of the trigger event at the first location. For example, as noted above, the trigger event may include a facial recognition match. For instance, in the example, assume that a known bank robber has entered the bank. The face of the bank robber may be seen (i.e., received) by an audio/video portion of client electronic device 38 (e.g., a security camera), and security process 10 may compare the face of the bank robber to a facial recognition database that includes a plurality of people. In the example, if the face of the bank robber matches a face stored in the facial recognition database that is associated with a criminal record (e.g., bank robbery, assault, a felony, etc.), such as a blacklist, then security process 10 may determine 302 the occurrence of the trigger event at the first location (e.g., the bank). Conversely, if the face of the bank robber does not match a face stored in the facial recognition database that is associated with a criminal record (e.g., bank robbery, assault, a felony, etc.), perhaps due to the bank robber never having been caught before, or if the face of another customer does not match a face stored in the facial recognition database that is associated with a criminal record, or if the face of another person in the bank matches a face stored in the facial recognition database that is on a white list (e.g., a bank employee or well-known customer), then security process 10 may determine that the occurrence of the trigger event at the first location (e.g., the bank) has not occurred. It will be appreciated that security process 10 may also include an object identification database, such that if an object (e.g., a gun or knife) is seen (i.e., received) by an audio/video portion of client electronic device 38 (e.g., a security camera), security process 10 may compare the image of the object to an object recognition database that includes a plurality of objects that is associated with a crime. As such, should there be a match, then security process 10 may determine 302 the occurrence of the trigger event at the first location (e.g., the bank).

As another example, as noted above, the trigger event may include a noise matched to a noise database. For instance, in the example, assume that a person has entered the bank and fires a gun. The sound of the gun firing may be heard (i.e., received) by an audio/video portion of client electronic device 38 (e.g., a security camera microphone), and security process 10 may compare the sound of the gun firing to a noise print database that includes a plurality of noises. In the example, if the sound of the gun firing matches a sound print/profile stored in the noise print database of a gun firing, then security process 10 may determine 302 the occurrence of the trigger event at the first location (e.g., the bank). Conversely, if another sound that is similar to that of a gun firing does not match a sound print/profile stored in the noise print database (e.g., someone dropping a heavy book on the ground), then security process 10 may determine that the occurrence of the trigger event at the first location (e.g., the bank) has not occurred. It will be appreciated that different guns may include different sound profiles in the noise print database. As such, the noise print database may include the sound print/profiles of multiple guns, as well as sound print/profiles of things that sound like guns, but can be identified as not being a gun (e.g., someone dropping a heavy book on the ground). Client electronic device may include sensors that detect the specific acoustic signature of a gunshot to be compared in the noise print database, and may also be able to determine the exact time and location of the gunshot. In some implementations, location may be determined by measuring the amount of time it takes for the sound of the gunshot to reach sensors in different locations.

As another example, as noted above, the trigger event may include a voice activation command. For instance, in the example, assume that a person has entered the bank and says something like “Give me all your money!” In some implementations, that statement may be heard (i.e., received) by an audio/video portion of client electronic device 38 (e.g., a security camera microphone), and security process 10 may use ASR to determine what was said, and compare what was said to a voice database that includes a plurality of statements. In the example, if the statement matches a statement stored in the voice database as being a possible robbery, then security process 10 may determine 302 the occurrence of the trigger event at the first location (e.g., the bank). Conversely, if another statement is received that does not match a statement stored in the voice database (e.g., “I would like to make a withdrawal please”), then security process 10 may determine that the occurrence of the trigger event at the first location (e.g., the bank) has not occurred. It will be appreciated that different statements may be included in the voice database that may or may not be considered as being a possible robbery. It will also be appreciated that the statements may be statements made by the bank teller, such as “we are being robbed” or something more secretive such as “I will do what you say, please do not hurt anyone.” These expressions may be identified using known ASR technology, and compared to the statements stored in the voice database as being a trigger event, and in some implementations, machine learning may be used to determine whether the expression should be identified as being a trigger event, even if it is not an exact match to the phrase stored in the voice database. It will also be appreciated that the voice database may be a voice print database, such that anything said by someone could identify that person as being on a blacklist (e.g., a known criminal) or a whitelist (e.g., a bank employee) using the acoustic properties of the voice (e.g., tone, frequency, etc.).

As another example, as noted above, the trigger event may include a manual activation. For instance, in the example, assume that a person has entered the bank and says something like “Give me all your money!” In some implementations, the bank teller (or other person in the bank such as a security guard) may manually press an event trigger button under the counter. In some implementations, the bank teller may manually activate the trigger event by doing some such as, e.g., opening the cash drawer without entering a sale, or with a cash drawer button that opens the cash drawer and also triggers the trigger event.

In some implementations, security process 10 may send 304 a real-time video feed (e.g., I/O 15) of the first location to a first responder based upon, at least in part, determining the occurrence of the trigger event at the first location. For instance, and continuing with the above example and referring at least to the example implementation of FIG. 4 showing an alternative view 400 of the network of FIG. 1, assume that security process 10 has determined 302 the occurrence of a triggering event (e.g., a gunshot has been recognized). In the example, once a trigger event has been determined to have occurred (e.g., at client electronic device 38), security process 10 may begin sending 304 (e.g., uploading) the real-time video feed (e.g., I/O 15) of the bank to a remote server (e.g., computer 12, which may be considered part of a cloud environment in some implementations). In some implementations, the video feed may be encrypted using any known encryption techniques. In some implementations, once a trigger event has been determined to have occurred, security process 10 may begin sending 304 (e.g., streaming) the real-time video feed of the bank to another user (e.g., user 48 via client electronic device 40), who may be a law enforcement officer (or other first responder), or may be someone working at a security center. In some implementations, once a trigger event has been determined to have occurred, security process 10 may begin sending 304 (e.g., uploading) the real-time video feed of the bank to a remote server (e.g., computer 12), which may be accessed by user 48 (e.g., a law enforcement officer or dispatch/security center worker). In some implementations, the feed itself or data provided along with the feed may include the name of the business and the address, which may be scrolling across the bottom of the screen viewing the feed. In some implementations, any measured latency time between what is being viewed and when it was originally captured may be displayed with the feed so the responding police officer knows how “live” the feed is.

In some implementations, security process 10 may be operational (e.g., recording) 24/7 watching and listening to the customer opposite the bank teller (or clerk) at a counter. In some implementations, once a trigger event has been determined, security process 10 may go back in time and have recorded the previous 3-4 minutes to be sent along with the live feed of video and audio to, e.g., the dispatcher, and the encrypted and secure cloud simultaneously.

In some implementations, sending 304 the real-time video feed of the first location to the first responder may include receiving 306 authorization to view the real-time video feed of the first location from a security center. For instance, in some implementations, and still referring to the example implementation of FIG. 4, once security process 10 begins sending 304 the real-time video feed (e.g., I/O 15) of the bank to the call center, this video feed may be reviewed by someone at the call center. Should the reviewer determine that a crime is in progress, that user may (e.g., via security process 10 and client electronic device 40) send a link and/or decryption credentials to the law enforcement officer that when selected, gives them access to the video (for download or streaming) in real-time. The link may be sent via email, text, pop up window, or any other method of communication. In the example, by clicking on the link, security process 10 may receive 306 authorization for the law enforcement office to view the real-time video feed (e.g., directly from client electronic device 38 and/or computer 12). In some implementations, the call center need not necessarily review the feed to determine that a crime is happening, and the link and/or decryption credentials may be automatically sent to the law enforcement officer. It will be appreciated that while encryption may be beneficial, it is not necessary to practice the present disclosure. In some implementations, when activated by a trigger event, security process 10 may send the real-time feed to computer 12, and security process 10 may then alert (e.g., automated call, text, email, pop up window, etc.) the local law enforcement call center (e.g., dispatcher) to the existence of the real-time feed and enable the responding operator to provide the above-noted link of the real-time feed to the responding officers. As noted above, the link and/or decryption credentials may be automatically sent to the law enforcement officer without requiring action by the responding operator.

In some implementations, whether the link and/or decryption credentials are automatically sent to the law enforcement officer without requiring action by the responding operator may be based upon a confidence level of the trigger event. For example, determining that a gun was fired or brought into a bank may provide a higher confidence of a bank robbery than an ASR based expression received by/from the bank teller or would-be bank robber. As such, in the example, determining that a gun was fired or brought into the bank may cause the link and/or decryption credentials (e.g., unique code or hash or login credentials to a website/cloud portal) to be automatically sent to the law enforcement officer without requiring action by the responding operator, whereas determining that something was said in the bank may require the responding operator to review the real-time feed to verify a robbery prior to sending the link and/or decryption credentials to the law enforcement officer (e.g., to check for a false alarm). As such, security process 10 may determine what the trigger event is, and then act accordingly based upon the confidence level of each trigger event type.

In some implementations, security process 10 may store 308 the real-time video feed of the first location in remote storage based upon, at least in part, determining 302 the occurrence of the trigger event at the first location. For instance, as noted above, assume that security process 10 has determined 302 the occurrence of a triggering event (e.g., a gunshot has been recognized). In the example, once a trigger event has been determined to have occurred, security process 10 may begin sending 304 (e.g., uploading/streaming) the real-time video feed of the bank to a remote server (e.g., computer 12). In some implementations, the video feed may be encrypted using any known encryption techniques.

In some implementations, security process 10 may remain in an activated (triggered) state until the dispatcher (or other authorized user) triggers the release of the feed.

While a bank is described in the example, this should be taken as example only and not to otherwise limit the scope of the disclosure. For example, delivery trucks may be wired with RFID boundaries, which would be activated (as a trigger event) when someone without the driver's RFID badge enters the truck's package area. The bank may also be a store, or someone's home.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
monitoring, by a computing device, for a trigger event at a first location;
determining an occurrence of the trigger event at the first location;
sending a real-time video feed of the first location to a first responder based upon, at least in part, determining the occurrence of the trigger event at the first location.

2. The computer-implemented method of claim 1 wherein sending the real-time video feed of the first location to the first responder includes receiving authorization to view the real-time video feed of the first location from a security center.

3. The computer-implemented method of claim 1 further comprising storing the real-time video feed of the first location in remote storage based upon, at least in part, determining the occurrence of the trigger event at the first location.

4. The computer-implemented method of claim 1 wherein the trigger event includes a facial recognition match.

5. The computer-implemented method of claim 1 wherein the trigger event includes a noise matched to a noise database.

6. The computer-implemented method of claim 1 wherein the trigger event includes a voice activation command.

7. The computer-implemented method of claim 1 wherein the trigger event includes manual activation.

8. A computer program product residing on a computer readable storage medium having a plurality of instructions stored thereon which, when executed across one or more processors, causes at least a portion of the one or more processors to perform operations comprising:
monitoring for a trigger event at a first location;
determining an occurrence of the trigger event at the first location;
sending a real-time video feed of the first location to a first responder based upon, at least in part, determining the occurrence of the trigger event at the first location.

9. The computer program product of claim 8 wherein sending the real-time video feed of the first location to the first responder includes receiving authorization to view the real-time video feed of the first location from a security center.

10. The computer program product of claim 8 wherein the operations further comprise storing the real-time video feed of the first location in remote storage based upon, at least in part, determining the occurrence of the trigger event at the first location.

11. The computer program product of claim 8 wherein the trigger event includes a facial recognition match.

12. The computer program product of claim 8 wherein the trigger event includes a noise matched to a noise database.

13. The computer program product of claim 8 wherein the trigger event includes a voice activation command.

14. The computer program product of claim 8 wherein the trigger event includes manual activation.

15. A computing system including one or more processors and one or more memories configured to perform operations comprising:
monitoring for a trigger event at a first location;
determining an occurrence of the trigger event at the first location;
sending a real-time video feed of the first location to a first responder based upon, at least in part, determining the occurrence of the trigger event at the first location.

16. The computing system of claim 15 wherein sending the real-time video feed of the first location to the first responder includes receiving authorization to view the real-time video feed of the first location from a security center.

17. The computing system of claim 15 wherein the operations further comprise storing the real-time video feed of the first location in remote storage based upon, at least in part, determining the occurrence of the trigger event at the first location.

18. The computing system of claim 15 wherein the trigger event includes a facial recognition match.

19. The computing system of claim 15 wherein the trigger event includes a noise matched to a noise database.

20. The computing system of claim 15 wherein the trigger event includes a voice activation command.

21. The computing system of claim 15 wherein the trigger event includes manual activation.
